(19) United States
(12) Patent Application Publication
(10) Pub. No.: US 2020/0283335 A1
(43) Pub. Date: Sep. 10, 2020

(54) PROTECTIVE PANELS WITH ANTI-GLARE COATING

(71) Applicant: HEWLETT-PACKARD DEVELOPMENT COMPANY, L.P., SPRING, TX (US)

(72) Inventors: KUAN-TING WU, TAIPEI CITY (TW); KUO-CHIH HUANG, TAIPEI CITY (TW); HANG YAN YUEN, FORT COLLINS, CO (US); CHI HAO CHANG, TAIPEI CITY (TW)

(21) Appl. No.: 16/754,123

(22) PCT Filed: Nov. 16, 2017
(86) PCT No.: PCT/US2017/061887

§ 371 Date: Apr. 6, 2020

(51) Int. Cl. C03C 17/42; C03C 15/00; C03C 23/00; C03C 21/00; G02B 1/18; G02B 5/02

(52) U.S. Cl. CPC C03C 17/42; C03C 15/00; C03C 23/0075; C03C 23/0085; C03C 21/00; C03C 2217/78; G02B 5/0268; G02B 5/0221; C03C 2218/112; C03C 2217/732; C03C 2217/76; G02B 1/18

(57) ABSTRACT

In one example, a method is described, which may include chemically etching a glass substrate to form a porous surface, coating an anti-glare layer on the porous surface, coating an anti-fingerprint layer on the anti-glare layer, and curing the anti-glare layer and the anti-fingerprint layer formed on the porous surface to form a protective panel.

### BACKGROUND

Display devices such as a liquid crystal display, a plasma display, an organic electroluminescence (EL) display, an inorganic EL display, and a field emission display (FED) may have an anti-glare layer that is disposed on an outermost surface of a display. The anti-glare layer may reduce an amount of light that reflects off the display using the principle of optical interference. Such displays may include a display panel and a protective panel.

### BRIEF DESCRIPTION OF THE DRAWINGS

Examples are described in the following detailed description and in reference to the drawings, in which:

FIG. 1 is an example method for forming a protective panel with an anti-glare layer and an anti-fingerprint layer;

FIG. 2 is another example method for forming a protective panel with an anti-glare layer and an anti-fingerprint layer;

FIG. 3 is an example process for sourcing an anti-glare layer and an anti-fingerprint layer on a glass substrate;

FIG. 4 is another example process for forming an anti-glare layer and an anti-fingerprint layer on a glass substrate;

FIG. 5 is another example process for forming an anti-glare layer and an anti-fingerprint layer on a glass substrate;

FIG. 6 is another example process for forming an anti-glare layer and an anti-fingerprint layer on a glass substrate;

FIG. 7 illustrates a side view of an example protective panel;

FIG. 8 illustrates a schematic representation of an example porous surface on the glass substrate; and

FIG. 9 is a side view of an example display including a display panel and a protective panel.

### DETAILED DESCRIPTION

An anti-glare treatment may be used on an outermost surface of a display (e.g., a liquid crystal display) for inhibiting reflection of an exterior light. The anti-glare treatment may use a chemical etching process on a surface of a glass substrate (i.e., cover glass) to create an anti-glare effect. For example, the chemical etching process may form an uneven structure on the surface of the display to have effects on scattering of a reflected light from the surface and blurring of a reflected image on the surface.

Chemical etching process for forming the anti-glare layer on the glass substrate may include a significant running cost and a low production yield rate (e.g., 20-25%). For example, chemical etching process for forming the anti-glare layer may take about 50-60 minutes to achieve >20% haze with a production yield rate of 20-25%, which can result in the significant running cost. Further, an anti-glare coat may be sprayed on an un-etched cover glass. However, the anti-glare spray coated un-etched cover glass may have low pencil hardness (e.g., <4 H) due to poor bonding at the interface of the anti-glare coat and the cover glass. Also, low pencil hardness on the anti-glare spray coated un-etched cover glass may cause a panel scuff test failure.

Examples described herein may include a method for chemically etching a glass substrate to form a porous surface, coating an anti-glare layer on the porous surface, coating an anti-fingerprint layer on the anti-glare layer, and curing the anti-glare layer and the anti-fingerprint layer formed on the porous surface to form a protective panel.

Examples described herein may apply a chemical etching process and followed by an anti-glare coating and anti-finger print coating on the glass substrate (e.g., cover glass) to obtain stabilized surface hardness and achieve high production yield rate (i.e., 80-90%). The anti-glare coating and the anti-fingerprint coating formed on the chemically etched glass substrate may have a pencil hardness of about 6 H to 10 H. Further, the combination of chemical etching process and anti-glare spray coating process can increase production yield rate and resolve the panel scuff test issue due to enhancement in the pencil hardness. Examples described herein may enhance the bonding between the anti-glare coating and chemical etched surface of the glass substrate.

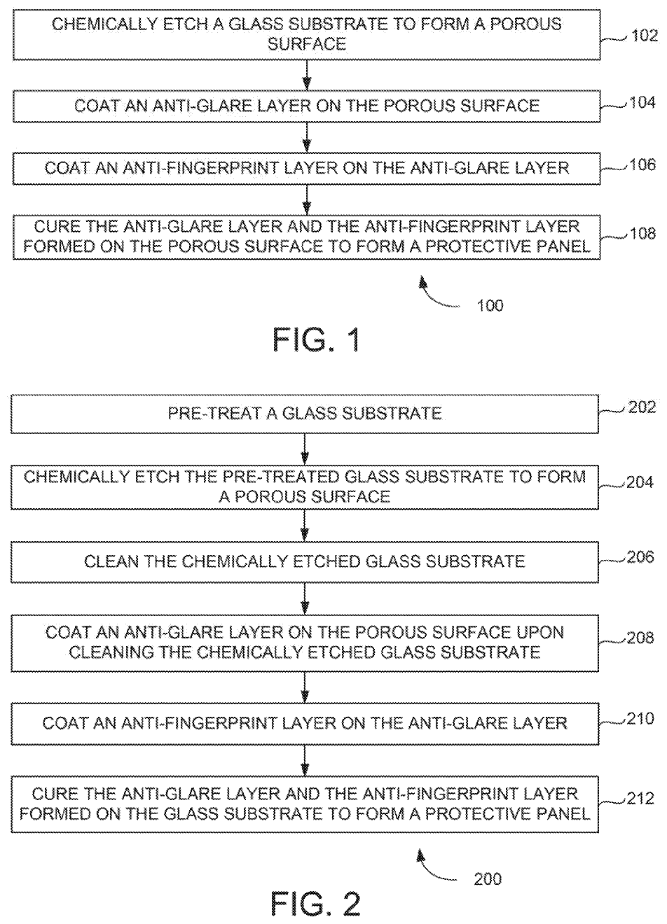

FIG. 1 is an example method 100 for forming a protective panel with an anti-glare layer and an anti-fingerprint layer. For example, protective panel may be a tempered glass, a touch panel, or an outermost surface of a display device. In other examples, the protective panel may be disposed on a display having the touch panel. At 102, a glass substrate (e.g., a transparent substrate) may be chemically etched to form a porous surface. In one example, a surface of the glass substrate may be chemically etched in an acid solution for about 3-15 minutes to form the porous surface. Example porous surface may include a nano-porous surface or a micro-porous surface.

At 104, the anti-glare layer may be coated on the porous surface to prevent glaring. For example, the anti-glare layer may be an optically clear coat formed of a mixture of tetraethylorthosilicate (TEOS) and titanium alkoxide gels. At 106, the anti-fingerprint layer may be coated on the anti-glare layer to prevent fingerprint pollution (e.g., fingerprint generation on the touch screen) on an upper surface of the anti-glare layer. In other examples, the anti-fingerprint layer may be coated on the anti-glare layer to prevent external pollutants from being attached to the upper surface of the anti-glare layer. For example, the anti-fingerprint layer may be formed of tetraethylorthosilicate (TEOS), long chain alkyl silanes such as dodecyltrimethoxysilane, and/or fluoropolymers. In one example, the anti-glare layer and the anti-fingerprint layer are applied on the porous surface of the glass substrate as a spray coat. At 108, the anti-glare layer and the anti-fingerprint layer formed on the porous surface may be cured to form the protective panel. In one example, the anti-glare layer and the anti-fingerprint layer formed on the porous surface can be cured at a temperature in a range of 150-200° C. for about 20-60 minutes.

FIG. 2 is another example method 200 for forming a protective panel with an anti-glare layer and an anti-fingerprint layer. At 202, a glass substrate may be pre-treated. For example, pre-treating the glass substrate may include cleaning, chemical strengthening, and drying the glass substrate. Further, a photo-resist coat may be formed on the pre-treated glass substrate. Furthermore, an upper surface of the photo-resist coat may be irradiated (e.g., exposed to electromagnetic radiation such as ultra-violet (UV) rays) through a mask to form a pattern on the surface of the glass substrate.

At 204, the pre-treated glass substrate may be chemically etched to form a porous surface (e.g., a nano-porous surface or a micro-porous surface). In one example, the patterned upper surface of the glass substrate is chemically etched to form the porous surface. At 206, the chemically etched glass substrate may be cleaned. In one example, the chemically etched glass substrate may be cleaned using an ultrasonic cleaning and/or a plasma cleaning.

At 208, an anti-glare layer may be coated on the porous surface upon cleaning the chemically etched glass substrate. At 210, an anti-fingerprint layer may be coated, on the anti-glare layer. At 212, the anti-glare layer and the anti-fingerprint layer formed on the glass substrate may be cured to form the protective panel.

In one example, the anti-glare layer and the anti-fingerprint layer formed on the porous surface are cured together at a temperature in a range of 150-200° C. for about 20-60 minutes. In another example, anti-glare layer and the anti-fingerprint layer formed on the porous surface are separately cured. For example, the anti-glare layer formed on the porous surface may be cured at a temperature in a range of 150-200° C. for about 20-60 minutes, prior to coating the anti-fingerprint layer. Then, the anti-fingerprint layer may be cured at a temperature in a range of 150-180° C. for about 20-60 minutes.

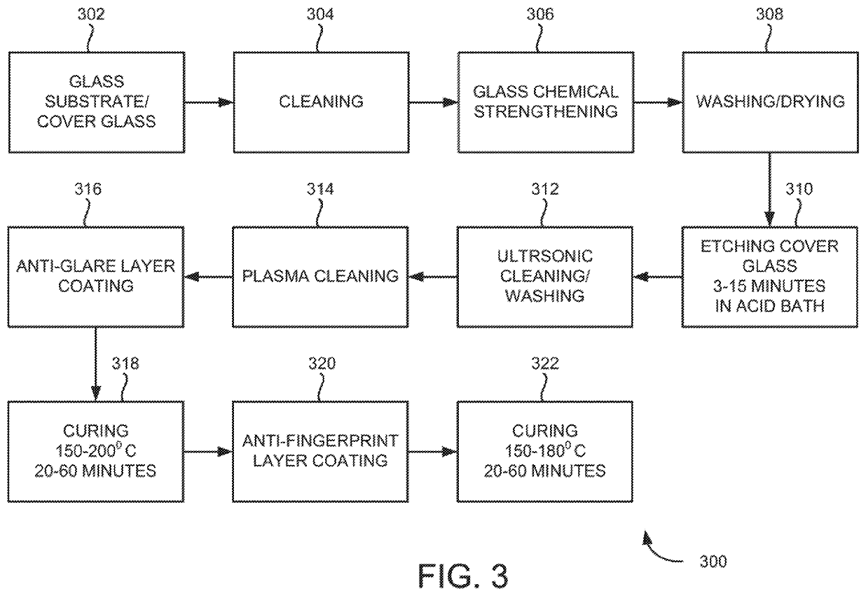

FIG. 3 is an example process 300 for forming an anti-glare layer and an anti-fingerprint layer on a glass substrate/cover glass. At 302, the cover glass may be provided. At 304, the cover glass may be cleaned. At 306, the cover glass may be chemically strengthened, for instance, using a post-production chemical process. Example post-production chemical process may use an ion-exchange process. The chemically strengthened glass may have an increased strength because of the post-production chemical process. At 308, the chemically strengthened cover glass may be washed (e.g., to remove any adhered chemical particles) and/or dried before exposing the cover glass to chemical etching.

At 310, the cover glass may be chemically etched in an acid solution for about 3-15 minutes to form a micro-porous/nano-porous surface. At 312, the chemically etched cover glass may be cleaned, for instance, using an ultrasonic cleaning/washing. Ultrasonic cleaning may refer to a process that uses ultrasound (e.g., 20-400 kHz) and an appropriate cleaning solvent to clean items on the chemically etched surface. At 314, the chemically etched cover glass may be further cleaned, for instance, using a plasma cleaning. Plasma cleaning may refer to a process of removing organic matter from the chemically etched surface through the use of an ionized gas called plasma. Plasma cleaning may be performed in a vacuum chamber utilizing gases such as oxygen and/or argon gas.

At 316, an anti-glare layer may be coated (e.g., spray coated) on the porous surface. At 318, the anti-glare layer formed on the porous surface may be cured at a temperature in a range of 150-200° C. for about 20-60 minutes. At 320, an anti-fingerprint layer may be coated (e.g., spray coated) on the anti-glare layer. At 322, the anti-fingerprint layer may be cured at a temperature in a range of 150-180° C. for about 20-60 minutes.

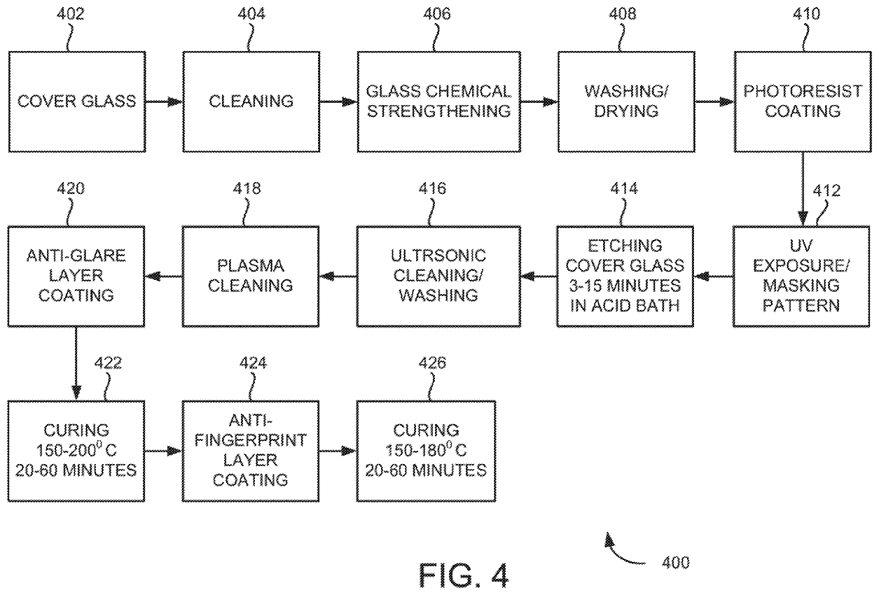

FIG. 4 is another example process 400 for forming an anti-glare layer and an anti-fingerprint layer on a glass substrate/cover glass. At 402, the cover glass may be provided. At 404, the cover glass may be cleaned. At 406, the cover glass may be chemically strengthened to increase the strength of the cover glass. At 408, the chemically strengthened cover glass may be washed and/or dried. At 410, a photo-resist coat may be formed on the chemically strengthened cover glass upon washing and/or drying the chemically strengthened cover glass.

At 412, an upper surface of the photo-resist coat may be exposed to electromagnetic radiation such as ultra-violet (UV) rays through a mask to form a pattern on the upper surface of the cover glass. At 414, the patterned upper surface of the cover glass may be chemically etched in an acid solution for about 3-15 minutes to form a micro-porous/nano-porous surface. At 416, the chemically etched cover glass may be cleaned, for instance, using an ultrasonic cleaning/washing. At 418, the chemically etched cover glass may be further cleaned, for instance, using a plasma cleaning.

At 420, an anti-glare layer may be coated (e.g., spray coated) on the porous surface. At 422, the anti-glare layer formed on the porous surface may be cured at a temperature in a range of 150-200° C. for about 20-60 minutes. At 424, an anti-fingerprint layer may be coated (e.g., spray coated) on the anti-glare layer. At 426, the anti-fingerprint layer may be cured at a temperature in a range of 150-180° C. for about 20-60 minutes.

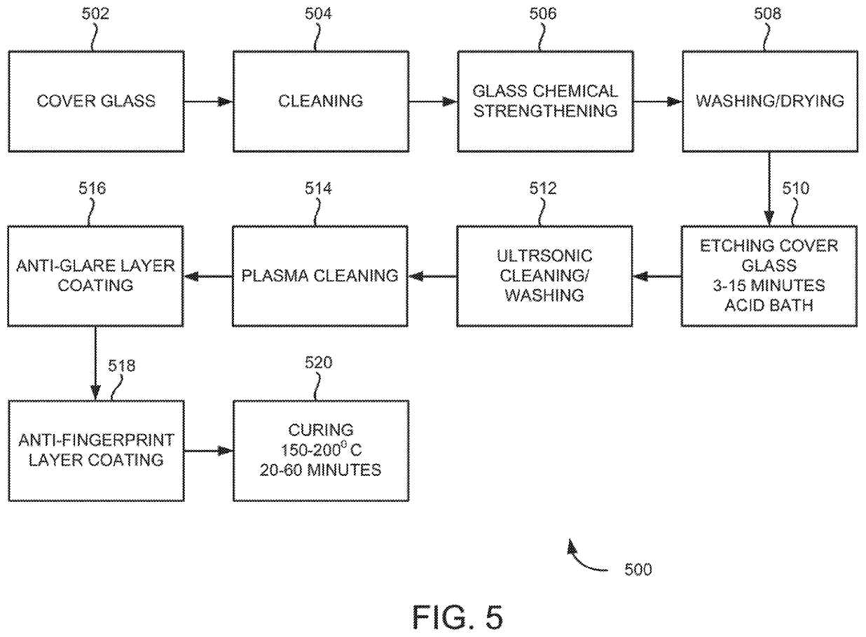

FIG. 5 is another example process 500 for forming an anti-glare layer and an anti-fingerprint layer on a glass substrate/cover glass. At 502, the cover glass may be provided. At 504, the cover glass may be cleaned. At 506, the cover glass may be chemically strengthened. At 508, the chemically strengthened cover glass may be washed (e.g., to remove any adhered chemical particles) and/or dried.

At 510, the cover glass may be chemically etched in an acid solution for about 3-15 minutes to form a micro-porous/nano-porous surface. At 512, the chemically etched cover glass may be cleaned, for instance, using an ultrasonic cleaning/washing. At 514, the chemically etched cover glass may be further cleaned, for instance, using a plasma cleaning.

At 516, an anti-glare layer may be coated (e.g., spray coated) on the porous surface. At 518, an anti-fingerprint layer may be coated (e.g., spray coated) on the anti-glare layer. At 520, the anti-glare layer and the anti-fingerprint layer may be cured at a temperature in a range of 150-200° C. for about 20-60 minutes.

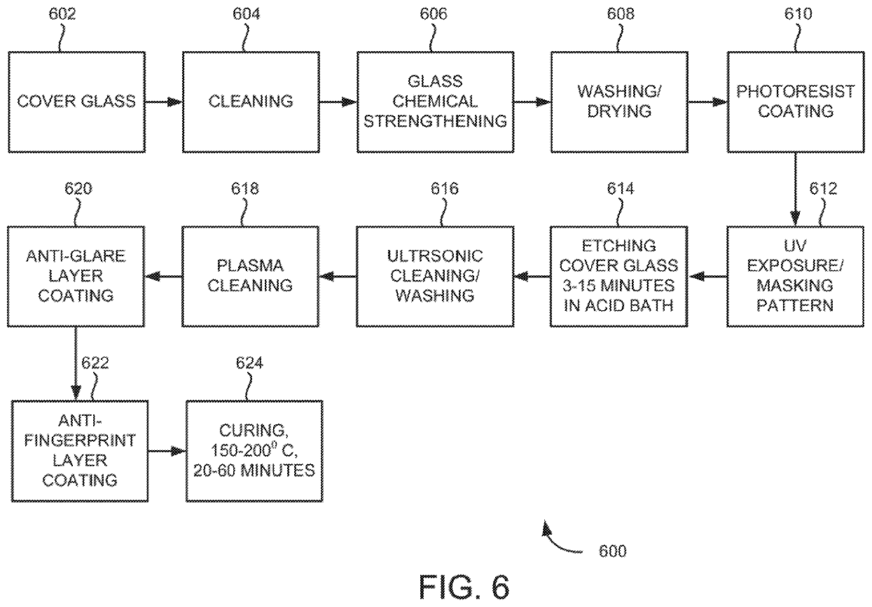

FIG. 6 is another example process 600 for forming an anti-glare layer and an anti-fingerprint layer on a glass substrate/cover glass. At 602, the cover glass may be provided. At 604, the cover glass may be cleaned. At 606, the cover glass may be chemically strengthened to increase the strength of the cover glass. At 608, the chemically strengthened cover glass may be washed and/or dried. At 610, a photo-resist coat may be formed on the chemically strengthened cover glass upon washing and/or drying the chemically strengthened cover glass.

At 612, an upper surface of the photo-resist coat may be exposed to electromagnetic radiation such as-ultra-violet (UV) rays through a mask to form a pattern on the upper surface of the cover glass. At 614, the patterned upper surface of the cover glass may be chemically etched in an acid solution for about 3-15 minutes to form a micro-porous/nano-porous surface. At 616, the chemically etched cover glass may be cleaned, for instance, using an ultrasonic cleaning/washing. At 618, the chemically etched cover glass may be further cleaned, for instance, using a plasma cleaning.

At 620, an anti-glare layer may be coated (e.g., spray coated) on the porous surface. At 622, an anti-fingerprint layer may be coated (e.g., spray coated) on the anti-glare layer. At 624, the anti-glare layer and the anti-fingerprint layer may be cured at a temperature in a range of 150-200° C. for about 20-60 minutes.

In some examples, some blocks of methods 100-600 may be performed substantially concurrently or in a different order than shown in FIGS. 1-6. In alternate examples of the present disclosure, methods 100-600 may include more or fewer blocks than are shown in FIGS. 1-6. In some examples, some blocks of methods 100-600 may, at certain times, be ongoing and/or may repeat.

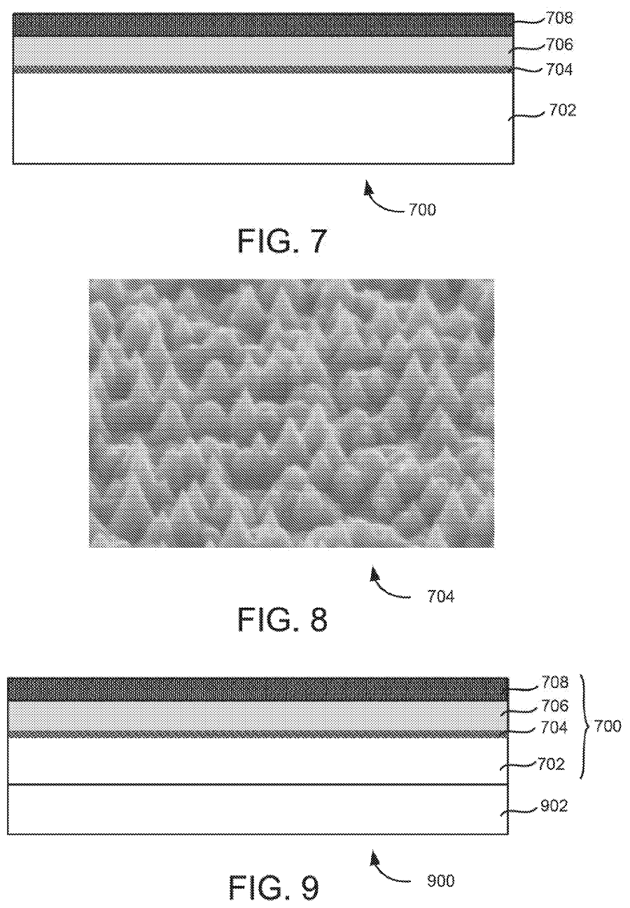

FIG. 7 illustrates a side view of an example protective panel 700. For example, protective panel 700 may be a tempered glass, a touch panel, or an outermost surface of a display device. In other examples, the protective panel 700 may be disposed on a display having touch panel.. Protective panel 700 may include a glass substrate 702 having a chemically etched surface 704. Further, protective panel 700 may include an anti-glare spray coat 706 formed on chemically etched surface 704. Chemically etched surface 704 may be formed by etching a surface of glass substrate 702 in an acid solution for about 3-15 minutes.

Chemically etched surface 704 may include a nano-porous surface or a micro-porous surface. FIG. 8 illustrates a schematic representation of an example nano-porous surface or a micro-porous surface (i.e., chemically etched surface 704). The porous surface may have pores less than or equal to 1 μm in diameter. Anti-glare spray coat 706 may be bonded to chemically etched surface 704 of glass substrate 702 in a cured state. Furthermore, protective panel 700 may include an anti-fingerprint spray coat 708 formed on anti-glare spray coat 706.

FIG. 9 is a side view of an example display 900 including a display panel 902 and a protective panel 700. Example display 900 can include, but not limited to, a display for a notebook computer, tablet personal computer (PC), smartphone, audio and video devices (e.g., stereo equipment and televisions), or the like. Example display panel 902 may include a liquid crystal display (LCD), light-emitting diode (LED), and the like. In one example, protective panel 700 may be bonded to display panel 902 using a bonding layer, for instance, an optically clear adhesive.

Even though FIGS. 1-9 describe about forming an anti-glare coating and an anti-fingerprint coating on the chemically etched glass substrate, examples described herein can also be applicable for other layers that can be formed on the chemically etched glass substrate, such as an anti-reflection coating. For example, anti-reflection coating can be applied directly on the chemically etched glass substrate or on the anti-glare coating formed on the chemically etched glass substrate.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A method comprising:
chemically etching a glass substrate to form a porous surface;
coating an anti-glare layer on the porous surface;
coating an anti-fingerprint layer on the anti-glare layer, and
curing the anti-glare layer and the anti-fingerprint layer formed on the porous surface to form a protective panel.

2. The method of claim 1, wherein chemically etching the glass substrate to form the porous surface, comprises:
chemically etching a surface of the glass substrate in an acid solution for about 3-15 minutes.

3. The method of claim 1, wherein curing the anti-glare layer and the anti-fingerprint layer formed on the porous surface comprises:
curing the anti-glare layer and the anti-fingerprint layer formed on the porous surface at a temperature in a range of 150-200° C. for about 20-60 minutes.

4. The method of claim 1, wherein the anti-glare layer and the anti-fingerprint layer are applied on the porous surface of the glass substrate as a spray coat.

5. The method of claim 1, wherein the porous surface comprises a nano-porous surface or a micro-porous surface.

6. A method, comprising:
pre-treating a glass substrate;
chemically etching the pre-treated glass substrate to form a porous surface;
cleaning the chemically etched glass substrate;
coating an anti-glare layer on the porous surface upon cleaning the chemically etched glass substrate;
coating an anti-fingerprint layer on the anti-glare layer; and
curing the anti-glare layer and the anti-fingerprint layer formed on the glass substrate to form a protective panel.

7. The method of claim 6, wherein pre-treating the glass substrate comprises cleaning, chemical strengthening, and drying the glass substrate.

8. The method of claim 7, further comprising:
forming a photo-resist coat on the pre-treated glass substrate; and
irradiating an upper surface of the photo-resist coat through a mask to forma pattern on the upper surface of the glass substrate, wherein the patterned upper surface is chemically etched to form the porous surface.

9. The method of claim 6, wherein cleaning the chemically etched glass substrate comprises at least one of ultrasonic cleaning and plasma cleaning of the chemically etched glass substrate.

10. The method of claim 6, wherein curing the anti-glare layer and the anti-fingerprint layer formed on the glass substrate comprises:
curing the anti-glare layer formed on the porous surface at a temperature in a range of 150-200° C. for about 20-60 minutes, prior to coating the anti-fingerprint layer; and
curing the anti-fingerprint layer at a temperature in a range of 150-180° C. for about 20-60 minutes.

11. The method of claim 6, wherein curing the anti-glare layer and the anti-fingerprint layer formed on the glass substrate comprises:
curing the anti-glare layer and the anti-fingerprint layer formed on the porous surface at a temperature in a range of 150-200° C. for about 20-60 minutes.

12. A protective panel comprising:
a glass substrate having a chemically etched surface;
an anti-glare spray coat formed on the chemically etched surface; and
an anti-fingerprint spray coat formed on the anti-glare spray coat.

13. The protective panel of claim 12, wherein the protective panel is a tempered glass or a touch panel of a display device.

14. The protective panel of claim 12, wherein the anti-glare spray coat is bonded to the chemically etched surface of the glass substrate in a cured state.

15. The protective panel of claim 12, wherein the chemically etched surface is formed by etching a surface of the glass substrate in an acid solution for about 3-15 minutes, and wherein the chemically etched surface of the glass substrate comprises a nano-porous surface or a micro-porous surface.
